(19) United States
(12) Patent Application Publication
(10) Pub. No.: US 2026/0052087 A1
(43) Pub. Date: Feb. 19, 2026

(54) AUTOMATIC SELECTION OF PROBE AND PATH TRACING MODES

(71) Applicant: Cisco Technology, Inc., San Jose, CA (US)

(72) Inventors: Jeremy William Riley, Whiteshill (GB); Ricardo Santos Morla, Vila Nova de Gaia (PT); Kyle Graham Schomp, Avon, OH (US); Ioannis Georgalis, London (GB); Arash Molavi Kakhki, San Francisco, CA (US)

(73) Assignee: Cisco Technology, Inc., San Jose, CA (US)

(21) Appl. No.: 18/807,189

(22) Filed: Aug. 16, 2024

(51) Int. Cl. H04L 43/10

(52) U.S. Cl. CPC H04L 43/10

(57) ABSTRACT

In one implementation, a device receives, via a user interface, an instruction to automate probing strategy formation for an agent in a computer network. The device obtains network telemetry from the computer network. The device selects, using the network telemetry, between a path tracing mode and a metric collection mode to form a probing strategy for the agent, based on the instruction. The device instructs the agent in the computer network to send one or more packets via the computer network according to the probing strategy.

### TECHNICAL FIELD

The present disclosure relates generally to computer systems, and, more particularly, to the automatic selection of probe and path tracing modes.

### BACKGROUND

As computer networks continue to grow in size and complexity, so too have the challenges in monitoring their performance. Indeed, traffic in a network may span any number of devices (e.g., access points, routers, etc.), paths, points of presence (PoPs) autonomous systems, and the like. Thus, identifying when performance is degraded in the network, as well as the root cause of that degradation, requires a high degree of visibility into the network.

To gain more insight into the operations of a network, various techniques have emerged over the years. In general, these techniques rely on a designated agent sending packets across the network, to assess how the network treats the packets. Determining which technique to use is often left to a network administrator based on their own expertise. However, even in instances in which the network administrator selects the ‘best’ technique for a given agent, the dynamic nature of the network means that this decision can quickly become outdated. Consequently, the agent may collect information that is of low value regarding the network or may even be unable to continue collecting information from the network using the selected technique.

### BRIEF DESCRIPTION OF THE DRA WINGS

The implementations herein may be better understood by referring to the following description in conjunction with the accompanying drawings in which like reference numerals indicate identically or functionally similar elements, of which:

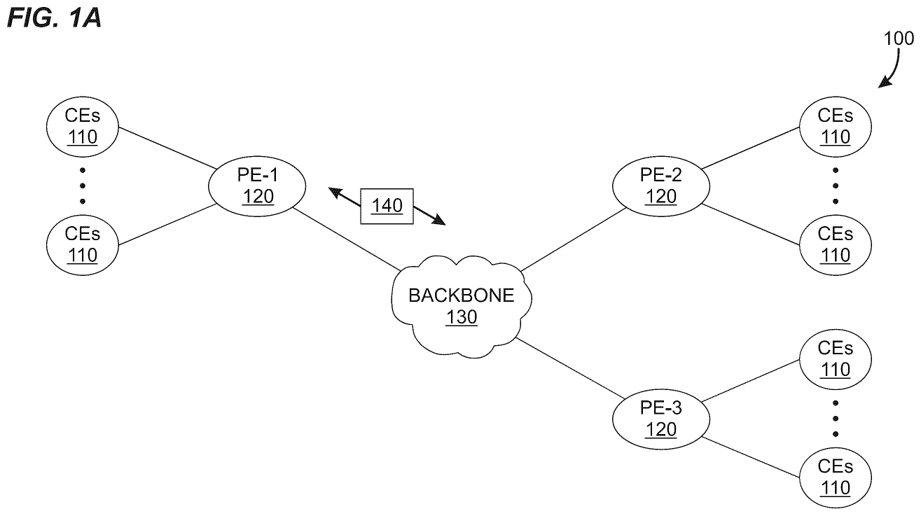

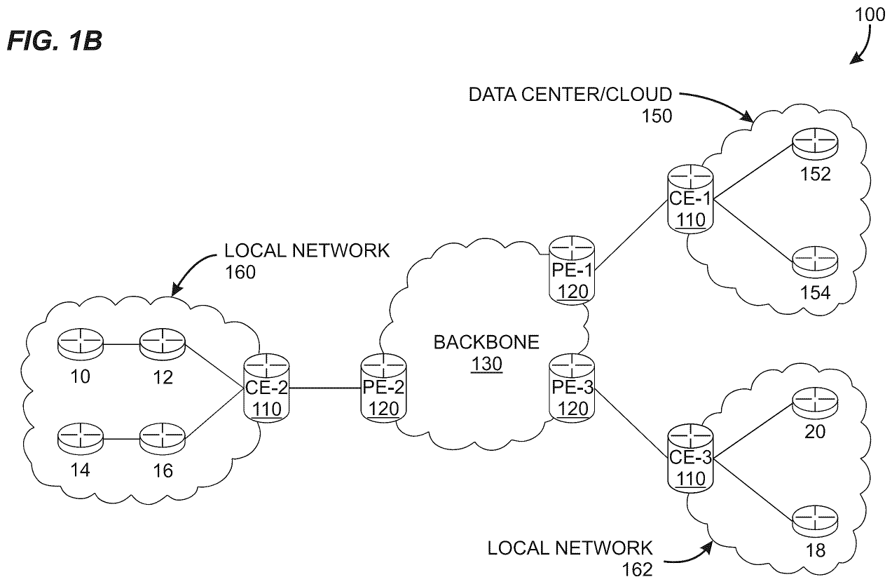

FIGS. 1A-1B illustrate an example communication network;

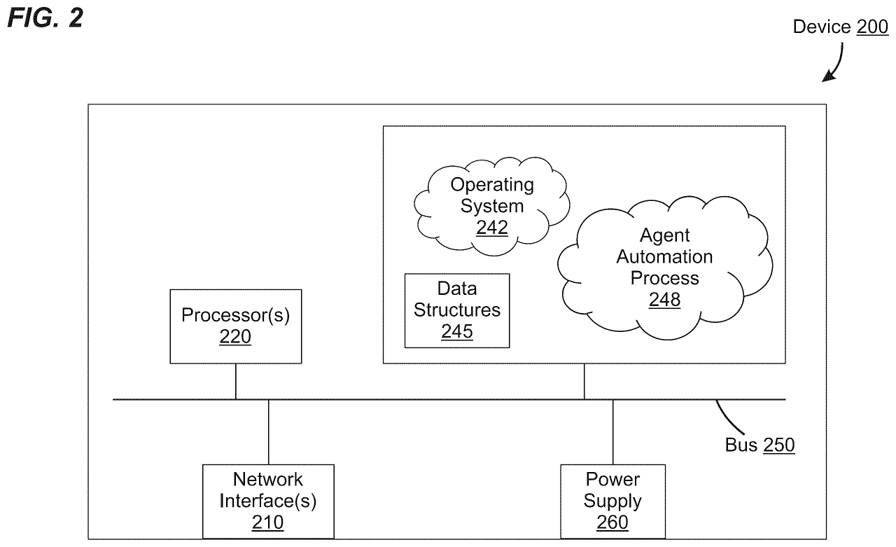

FIG. 2 illustrates an example network device/node;

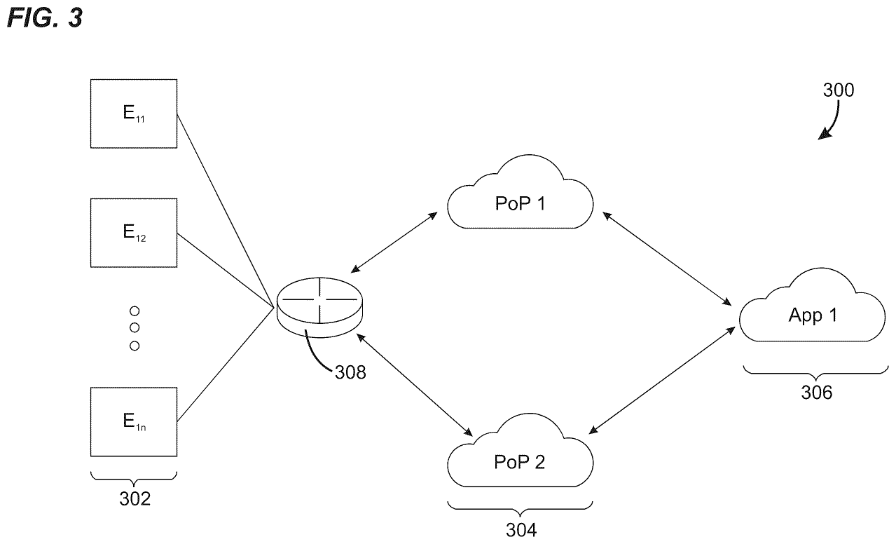

FIG. 3 illustrates an example of an edge router connecting to a cloud-hosted application via multiple points-of-presence (PoPs);

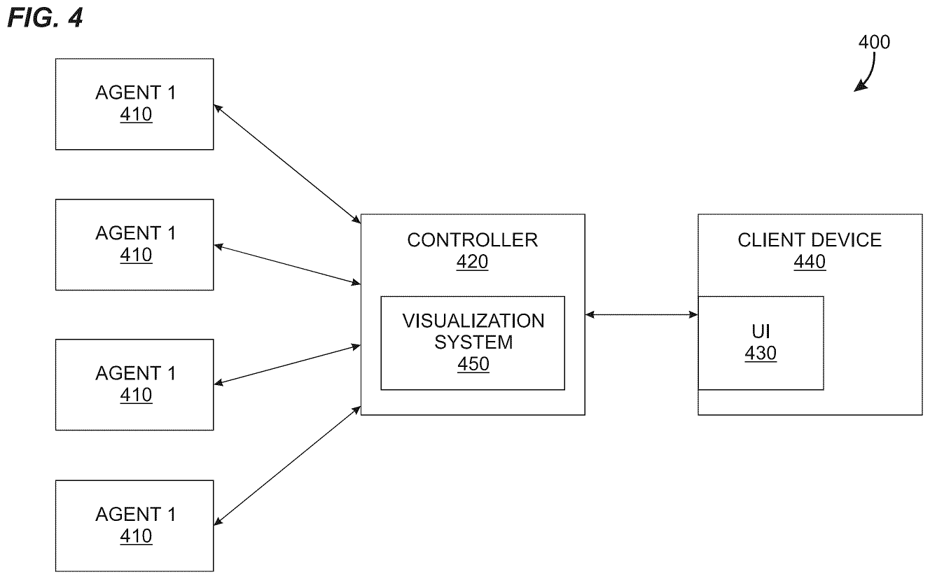

FIG. 4 illustrates an example architecture for a network observability intelligence platform;

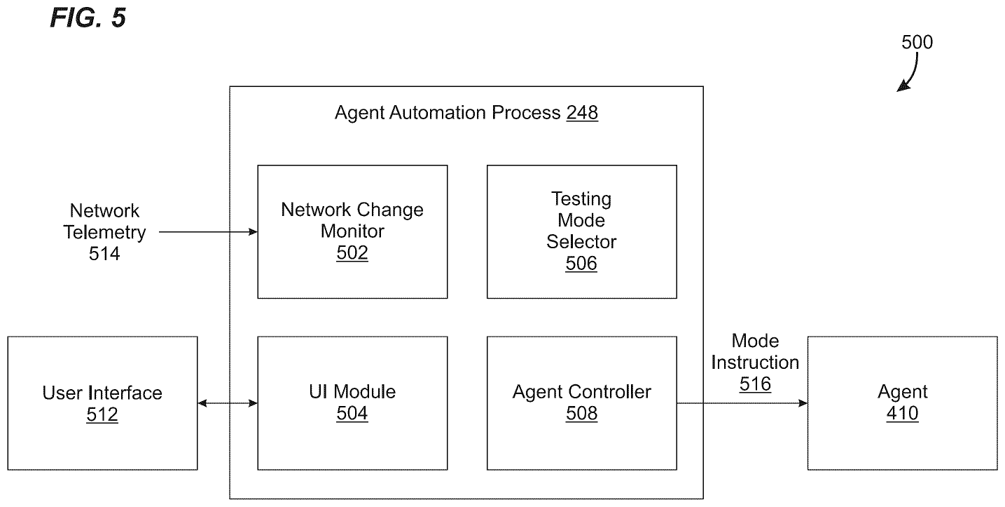

FIG. 5 illustrates an example architecture for the automatic selection of probe and path tracing modes;

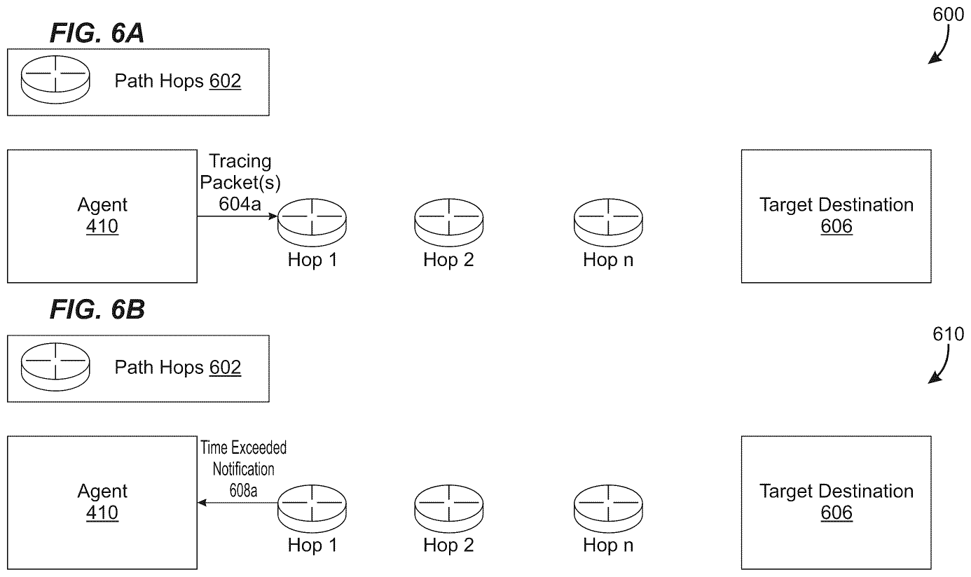

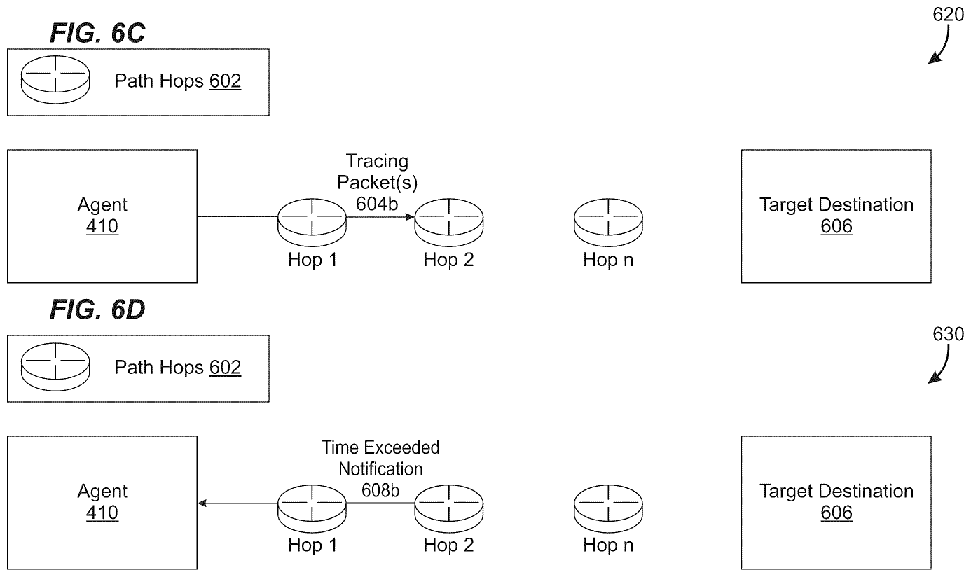

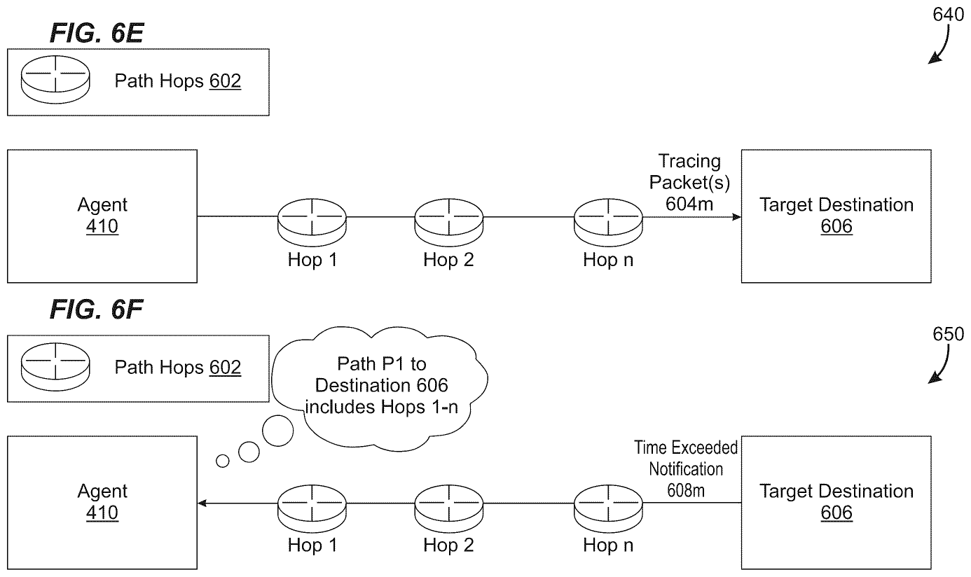

FIGS. 6A-6F illustrate examples of an agent performing automatic path tracing along a network path;

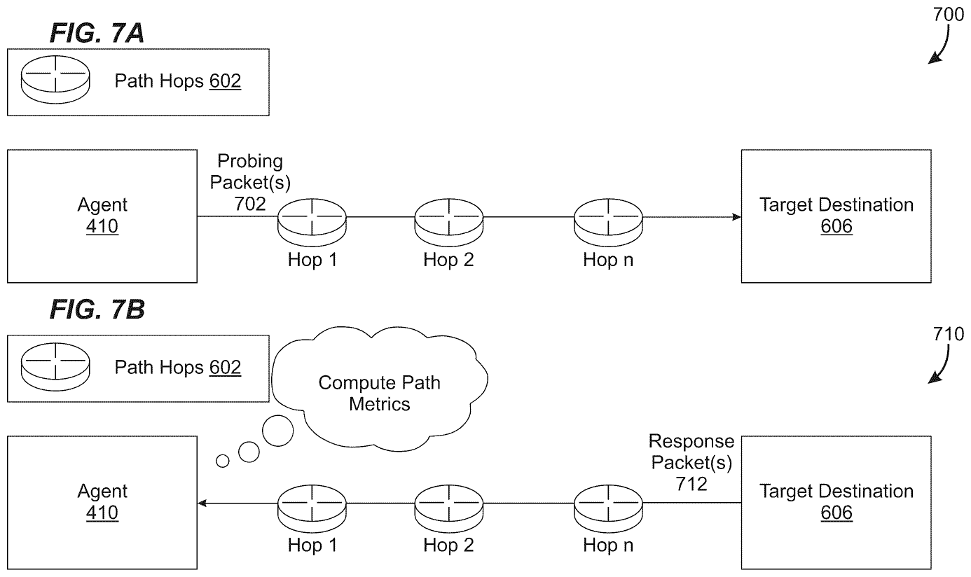

FIGS. 7A-7B illustrate examples of an agent performing path probing/metric collection along a network path; and

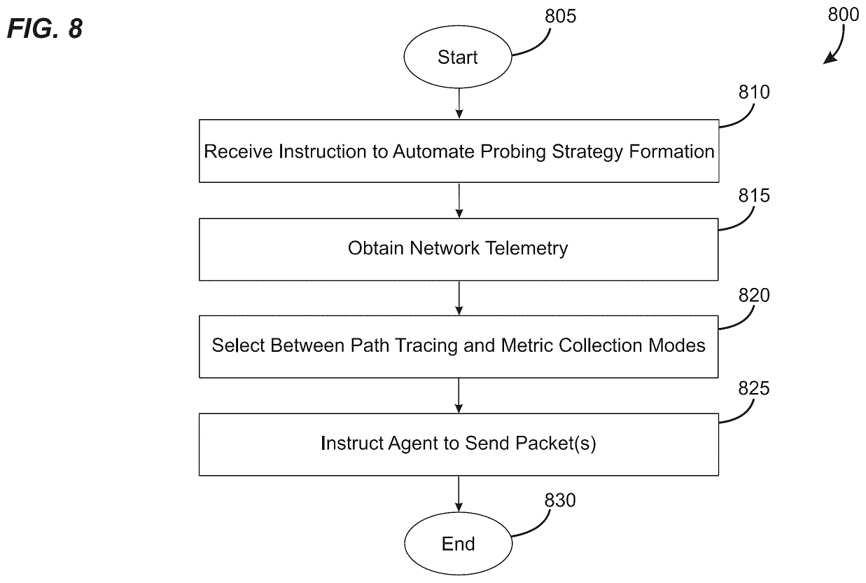

FIG. 8 illustrates an example simplified procedure for automatically selecting between probe and path tracing modes.

### DESCRIPTION OF EXAMPLE EMBODIMENTS

### Overview

According to one or more implementations of the disclosure, a device receives, via a user interface, an instruction to automate probing strategy formation for an agent in a computer network. The device obtains network telemetry from the computer network. The device selects, using the network telemetry, between a path tracing mode and a metric collection mode to form a probing strategy for the agent, based on the instruction. The device instructs the agent in the computer network to send one or more packets via the computer network according to the probing strategy.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of computer network 100 in greater detail, according to various embodiments. As shown, network backbone 130 may provide connectivity between devices located in different geographical areas and/or different types of local networks. For example, computer network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a agent automation process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, agent automation process 248 may also include computer executable instructions that, when executed by processor(s) 220, cause device 200 to perform the techniques described herein. To do so, in some embodiments, agent automation process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, agent automation process 248 may employ one or more supervised, unsupervised, or semi-supervised machine learning models. Generally, supervised learning entails the use of a training set of data, as noted above, that is used to train the model to apply labels to the input data. For example, the training data may include sample telemetry and/or path performance data that has been labeled as being indicative of a path performance level. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that agent automation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further embodiments, agent automation process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

FIG. 3 illustrates an example 300 of an edge router 308 accessing a cloud-hosted application or service 306. As shown, assume that there are n-number of endpoints 302 at a particular location for which edge router 308 provides external connectivity. An online application or service provider may maintain any number of points-of-presence (PoPs), such as PoPs 304, to which edge router 308 may connect. Accordingly, edge router 310 may access a cloud-hosted application or service 306, such as a SaaS application, via a first PoP among PoPs 304, a second PoP among PoPs 304, etc.

However, the network performance when accessing the cloud-hosted application or service 306 via PoPs 304 is not guaranteed. Indeed, ensuring that traffic SLAs are met may require adjustments:
To meet SLAs, exceptions might be required for traffic that should not be sent through the gateway but directly sent via Direct Internet Access (DIA) locally, in case the gateway is not able to provide a good enough performance for a specific kind of traffic, which highly depends on Peering between the Online application or service provider Gateway PoP and SaaS provider or intermediate Autonomous Systems (AS). For instance, it is sometimes recommended to send out VoIP traffic directly DIA to achieve better performance. However, this defeats the purpose of delivering WAN and security directly in the cloud while relying only on a very simple unique tunnel from all locations.
Selection of the “closest PoP” is usually based on either geo-location, AnyCast (e.g., for secure web gateways relying on HTTPS proxies), probing results (e.g., selecting the POP with the lowest latency), or by fixing a static PoP location (e.g., as is usually done when setting up fixed IPsec tunnels). However, online application or service providers tend to have rather dense sets of PoPs to which a location can connect. Thus, the closest PoP is not always the best one to use, in terms of providing the best possible application experience. In particular, a PoP might be struggling at certain times of the day to satisfy the SLA of the application traffic, while other nearby PoPs might not.
The performance of a given PoP can also vary between applications. Indeed, performance can be influenced by any or all of the following factors:
   Edge to PoP.
   POP load.
   POP to POP, if traffic is sent through a backbone.
   PoP to SaaS. Different PoPs might have different types of inter-connect or peering with SaaS services and might end up going to different SaaS physical endpoints, even if the SaaS exposes a single logical endpoint.

As discussed with respect to illustrative FIG. 4 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 4 is a block diagram of an example observability intelligence platform 400 that can implement one or more aspects of the techniques herein (e.g., through execution of agent automation process 248). The observability intelligence platform is a system that monitors and collects metrics of performance data for a network and/or application environment being monitored. At the simplest structure, the observability intelligence platform includes agents 410 (e.g., one or more agents) and one or more servers and/or controllers, such as the controller 420 (e.g., a device 200). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 420 (or controllers) as directed. Note that while FIG. 4 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents 410 may allow a controller to monitor performance of the application to determine such things as device metrics (e.g., type, configuration, resource utilization, etc.), network browser navigation timing metrics, browser cookies, application calls and associated pathways and delays, other aspects of code execution, etc.

Moreover, if a customer uses agents to run tests, probe packets may be configured to be sent from agents 410 to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page, i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 420 is the central processing and administration server for the observability intelligence platform. The controller 420 may serve a browser-based user interface (UI), which may be referred to as an interface 430 that is the primary interface for monitoring, analyzing, and troubleshooting the monitored environment. Specifically, the controller 420 can receive data from agents 410 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 430. The interface 430 may be viewed as a web-based interface viewable by a client device 440. In some implementations, a client device 440 can directly communicate with controller 420 to view an interface for monitoring data. The controller 420 can include a visualization system 450 for displaying the reports and dashboards related to the disclosed technology. In some implementations, the visualization system 450 can be implemented in a separate machine (e.g., a server) different from the one hosting the controller 420.

Notably, in an illustrative Software as a Service (SaaS) implementation, an instance of controller 420 may be hosted remotely by a provider of the observability intelligence platform 400. In an illustrative on-premises (On-Prem) implementation, an instance of controller 420 may be installed locally and self-administered.

The controllers 420 receive data from different agents, such as the agents 410 (e.g., Agents 1-4) deployed to monitor networks, applications, databases and database servers, servers, and end user clients for the monitored environment. Any of the agents 410 can be implemented as different types of agents with specific monitoring duties. For example, application agents may be installed on each server that hosts applications to be monitored. Instrumenting an agent adds an application agent into the runtime process of the application.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (e.g., an application instance) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

As noted above, to gain more insight into the operations of a network, various techniques have emerged over the years. In general, these techniques rely on a designated agent sending packets across the network, to assess how the network treats the packets. Determining which technique to use is often left to a network administrator based on their own expertise. However, even in instances in which the network administrator selects the ‘best’ technique for a given agent, the dynamic nature of the network means that this decision can quickly become outdated. Consequently, the agent may collect information that is of low value regarding the network or may even be unable to continue collecting information from the network using the selected technique.

By way of example, path tracing and round-trip probes are basic tools useful to understand a network path and the performance of communications over that path. To this end, various techniques have evolved over the years to perform such testing, such as the Internet Control Message Protocol (ICMP) ‘ping’ and ‘tracert’ functions, as well as techniques based on the actual protocols used, such as TCP.

One observation herein is that the most appropriate testing approach for any given agent depends on several factors such as the network configuration of the local system, the nature of the intermediate nodes, and the target system. However, selecting the best method to be used is difficult and requires expert knowledge or trail-and-error. In addition, Different host operating systems and releases may support different methods, requiring different configurations, thus making the configuration more complicating and difficult to maintain.

Furthermore, once a testing approach has been selected for a given agent, it may quickly become inappropriate because of any or all of the following reasons:
End user systems moving between different locations such as home, public Wi-Fi, and an office
Users connecting to VPNs
Changes to proxy and other middleware configuration
Changes to target system
Network changes or failures resulting
Etc.

Using multiple approaches at the same time would also create extra network traffic, extra load on the target server, even risk the testing traffic being blocked as malevolent.

As a result, it can be difficult to ensure that the most appropriate approach is in use by an agent at any given time.

### —Automatic Selection of Probe and Path Tracing Modes—

The techniques herein allow for the automatic selection of the testing approach for an agent at any given time by selecting between the best probing mode (e.g., to measure path metrics from an endpoint to a target) and path tracing mode (e.g., to identify hops along the path between the endpoint and the target). This ability is important for network visibility as each combination of target, endpoint, and routers in the path between them can require a different probe or path tracing mode. In some aspects, the techniques herein are also able to adjust the chosen strategy over time, in response to detected changes in telemetry from the network.

Illustratively, the techniques described herein may be performed by hardware, software, and/or firmware, such as in accordance with agent automation process 248, which may include computer executable instructions executed by the processor 220 (or independent processor of interfaces 210) to perform functions relating to the techniques described herein.

Specifically, according to various embodiments, a device receives, via a user interface, an instruction to automate probing strategy formation for an agent in a computer network. The device obtains network telemetry from the computer network. The device selects, using the network telemetry, between a path tracing mode and a metric collection mode to form a probing strategy for the agent, based on the instruction. The device instructs the agent in the computer network to send one or more packets via the computer network according to the probing strategy.

Operationally, FIG. 5 illustrates an example architecture 500 for the automatic selection of probe and path tracing modes, in various implementations. As shown, agent automation process 248 may include any or all of the following components: a network change monitor 502, a UI module 504, an agent mode selector 506, and/or an agent controller 508. As would be appreciated, the functionalities of these components may be combined or omitted. In addition, these components may be executed in a device or in a distributed manner, in which case the combination of executing devices can be viewed as their own singular device for purposes of executing agent automation process 248.

During execution, network change monitor 502 may be responsible for obtaining network telemetry 514 and detecting changes in the network by analyzing network telemetry 514 over time. To do so, network change monitor 502 may interact with a network controller, networking devices directly, user endpoint devices, or agents in the network, to collect network telemetry 514 either on a pull or push basis, as appropriate. In general, network telemetry 514 may include device level information (e.g., the current state or configuration of a given node in the network), path level information (e.g., the path used between to given nodes, the performance of that path, etc.), traffic level information (e.g., the type of application traffic conveyed via the network), or any other information indicative of the operation of the network.

In various implementations, UI module 504 may interact with a user interface 512, either locally or remotely to that of device 200 executing agent automation process 248, to allow a network administrator or other interested party to oversee the operations of any number of agents distributed throughout a network (e.g., agents 410). During these interactions, the user of user interface 512 may select an ‘automatic’ setting for a particular agent, a group of agents, or even globally across all agents that agent automation process 248 controls. In addition, in some cases, automatic control for a given agent may also be conditioned on one or more parameters set via user interface 512 such as a target destination for automated testing by a designated agent, a particular time during which the automatic control is active (e.g., during a certain time of day, during a designated day, etc.), or any other factor that may indicate when or how agent automation process 248 is to control the testing modes of the agent.

Setting of the ‘automatic’ parameter via user interface 512 may cause UI module 504 to signal to agent mode selector 506 that the indicated agent(s) are now under automatic control by agent automation process 248. In some implementations, the first time an agent is flagged for ‘automatic’ control, agent mode selector 506 may determine the set of possible testing modes for that agent and evaluate them to select the best one to use. To do so, agent mode selector 506 may consider information from network telemetry 514 such as any or all of the following:
Any errors that occurred while probing
Response rate to probes
Round trip times of probes
Whether path traces reached the target
Length of path to target
The size and number of gaps in the path trace
Etc.

In turn, agent mode selector 506 may notify agent controller 508 as to the selected testing mode. Agent controller 508 then sends a mode instruction 516 to the selected agent, such as agent 410, thereby instructing it to conduct path testing in accordance with the selected testing mode. In general, such testing may entail agents 410 sending packets via the network to test a given path to a designated target destination. The results of these tests may be reported back to agent automation process 248 over time as network telemetry 514, as well.

As would be appreciated, agent mode selector 506 may select a given testing mode for the agent to achieve a specific goal, which may fall into one of two categories: 1.) path tracing, which seeks to learn about the structure of the path, such as its constituent hops and links between hops, and 2.) path probing/metric collection, which seeks to quantify the performance of the path, such as its round trip time, packet loss, jitter, delay, throughput, or the like. Amongst these two modes, different options also exist, such as the protocol(s) used by the testing packets, their configurations, etc.

For instance, in the case of path tracing, ICMP ping and tracert represent two options for learning about the path and typically relies on UDP. However, further path tracing approaches also exist that rely on TCP, which may offer greater visibility in some cases, as ICMP may be blocked by some hops.

In addition, when performing metric collection, the probe packets may use any suitable protocol and, in some instances, the agent sending the packets may also craft the packets in a specific way and send them according to a defined timing. For instance, assume that the agent is to collect path performance metrics as they relate to a certain online application. In such a case, the agent may send probe packets along the path towards the application server that mimic actual traffic of the application, such as by controlling the size of the packets, their protocols (e.g., HTTP, etc.), their timing, and the like.

Accordingly, in some implementations, agent mode selector 506 may also select the specific way in which the agent is to perform the selected testing mode.

In various implementations, agent mode selector 506 may also revise its selections over time, based on any changes indicated by network change monitor 502 in network telemetry 514. To do so, agent mode selector 506 may consider factors such as, but not limited to, any or all of the following:
Time since the last testing approach was chosen
Changes to the network configuration of the node hosting the agent
Addition or removal of network adapters
Connection or disconnection from networks or Wi-Fi
Connection or disconnection from VPNs
Changes to IP configuration (e.g., address, routing tables, etc.)
Changes to the performance of probes
Probes that have been stable exhibit a change in behavior
Changes to the path indicated by path tracing
Changes to non-performance probe data
Time-to-live (TTL) measures of received packets
Protocol options and similar meta-data

In some implementations, agent mode selector 506 may only change testing modes when it determines that the new mode will produce more accurate results, as unnecessary changes can cause confusion for those analyzing the results. Such results may be collected as network telemetry 514 and reported by UI module 504 to user interface 512 for review by an administrator. As would be appreciated, by automatically selecting the testing mode for a given agent, the system is able to use the most suitable testing mode at any given time without excessive testing and with the ability to adapt over time to changing situations without user intervention.

FIGS. 6A-6F illustrate examples of an agent performing automatic path tracing along a network path, in some implementations. As shown in example 600 in FIG. 6A, assume that agent 410 is configured by agent controller 508 using a path tracing mode (e.g., ICMP-based tracing) selected by agent mode selector 506 with respect to a target destination 606. In such a case, agents 410 may send one or more tracing packets 604a towards target destination 606 via a path that includes any number of path hops 602 (e.g., a first through nth hop). Tracing packet(s) 604a may have TTL values set very low, causing them to expire when reaching the first hop.

As shown in example 610 in FIG. 6B, when the first path hop determines that the one or more tracing packets 604a have expired, it may return a time exceeded notification 608a to agent 410. This allows agents 410 to determine that the first hop is located along the path to target destination 606. In turn, agents 410 may send out tracing packet(s) 604b with increased TTL values, as shown in example 620 in FIG. 6C. Here, since the TTL was increased, those packets may expire prior to reaching the second hop, which then returns time exceeded notification 608b to agent 410. From notification 608b, agent 410 is then able to identify the second hop along the path to target destination 606.

Agent 410 may continue conducting its probing until, as shown in example 640 in FIG. 6E, its tracing packet(s) 604m reach target destination 606. In turn, target destination 606 may send a time exceeded notification 608m back to agents 410, as shown in example 650 in FIG. 6F. This allows 410 (or the entity analyzing its tracing results) to identify the path P1 to target destination 606 in the network as comprising hops 1-n. Such information is important both for purposes of assessing the performance of the path, as well as determining the root cause of any issues that arise.

FIGS. 7A-7B illustrate examples of an agent performing path probing/metric collection along a network path, in various implementations. As shown in example 700 in FIG. 7A, assume now that agent mode selector 506 has instead selected a metrics collection mode. In such a case, 410 may instead send probing packet(s) 702 towards target destination 606. Probing packet(s) 702 may, in some cases, mimic application traffic associated with target destination 606, which may be an application server. In turn, in example 710, target destination 606 may return response packet(s) 712 to agents 410, which allows it (or another entity) to compute the path metrics, such as the path delay, round trip time, jitter, packet loss (e.g., if agents 410 did not receive response packet(s) 712), or the like.

FIG. 8 illustrates an example of a simplified procedure 800 (e.g., a method) for automatically selecting between probe and path tracing modes, in accordance with one or more embodiments described herein. For example, a non-generic, specifically configured device (e.g., device 200) may perform procedure 800 by executing stored instructions (e.g., agent automation process 248). The procedure 800 may start at step 805, and continues to step 810, where, as described in greater detail above, the device may receive, via a user interface, an instruction to automate probing strategy formation for an agent in a computer network. In some implementations, the agent is hosted by an endpoint in the computer network.

At step 815, as detailed above, the device may obtain network telemetry from the computer network. In various implementations, the network telemetry indicates at least one of: a probing error, a probe response rate, a round trip time, a packet loss, a path length, or a gap in a packet trace.

At step 820, the device may select, using the network telemetry, between a path tracing mode and a metric collection mode to form a probing strategy for the agent, based on the instruction, as described in greater detail above. In some implementations, the device selects the path tracing mode and the one or more packets comprise path tracing packets to identify hops along a path in the computer network. In further implementations, the device selects the metric collection mode and the agent sends the one or more packets along a path in the computer network to collect at least one of: a round trip time metric, a delay metric, a loss metric, or a jitter metric.

At step 825, as detailed above, the device may instruct the agent in the computer network to send one or more packets via the computer network according to the probing strategy. In various implementations, the device may later form an updated probing strategy by updating the probing strategy to swap between the path tracing mode and the metric collection mode to select whichever mode was not selected when forming the probing strategy for the agent and instruct the agent to send one or more packets via the computer network according to the updated probing strategy. In one implementation, the device forms the updated probing strategy based in part on an amount of time that has elapsed since it formed the probing strategy. In a further implementation, the device forms the updated probing strategy in response to the network telemetry indicating a network configuration change for a host of the agent. In another implementation, the device forms the updated probing strategy based a change in one or more path performance metrics collected by the agent using the one or more packets. In yet a further implementation, the device forms the updated probing strategy based on an indication that a path via which the agent sent the one or more packets has changed.

Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments for the automatic selection of probe and path tracing modes, it is to be understood that various other adaptations and modifications may be made within the spirit and scope of the embodiments herein. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, at a device and via a user interface, an instruction to automate probing strategy formation for an agent in a computer network;
obtaining, by the device, network telemetry from the computer network;
selecting, by the device and using the network telemetry, between a path tracing mode and a metric collection mode to form a probing strategy for the agent, based on the instruction; and
instructing, by the device, the agent in the computer network to send one or more packets via the computer network according to the probing strategy.

2. The method as in claim 1, wherein the device selects the path tracing mode and the one or more packets comprise path tracing packets to identify hops along a path in the computer network.

3. The method as in claim 1, wherein the device selects the metric collection mode and the agent sends the one or more packets along a path in the computer network to collect at least one of: a round trip time metric, a delay metric, a loss metric, or a jitter metric.

4. The method as in claim 1, wherein the network telemetry indicates at least one of: a probing error, a probe response rate, a round trip time, a packet loss, a path length, or a gap in a packet trace.

5. The method as in claim 1, further comprising:
forming, by the device, an updated probing strategy by updating the probing strategy to swap between the path tracing mode and the metric collection mode to select whichever mode was not selected when forming the probing strategy for the agent; and
instructing, by the device, the agent to send one or more packets via the computer network according to the updated probing strategy.

6. The method as in claim 5, wherein the device forms the updated probing strategy based in part on an amount of time that has elapsed since it formed the probing strategy.

7. The method as in claim 5, wherein the device forms the updated probing strategy in response to the network telemetry indicating a network configuration change for a host of the agent.

8. The method as in claim 5, wherein the device forms the updated probing strategy based a change in one or more path performance metrics collected by the agent using the one or more packets.

9. The method as in claim 5, wherein the device forms the updated probing strategy based on an indication that a path via which the agent sent the one or more packets has changed.

10. The method as in claim 1, wherein the agent is hosted by an endpoint in the computer network.

11. An apparatus, comprising:
one or more network interfaces;
a processor coupled to the one or more network interfaces and configured to execute one or more processes; and
a memory configured to store a process that is executable by the processor, the process when executed configured to:
receive, via a user interface, an instruction to automate probing strategy formation for an agent in a computer network;
obtain network telemetry from the computer network;
select, using the network telemetry, between a path tracing mode and a metric collection mode to form a probing strategy for the agent, based on the instruction; and
instruct the agent in the computer network to send one or more packets via the computer network according to the probing strategy.

12. The apparatus as in claim 11, wherein the apparatus selects the path tracing mode and the one or more packets comprise path tracing packets to identify hops along a path in the computer network.

13. The apparatus as in claim 11, wherein the apparatus selects the metric collection mode and the agent sends the one or more packets along a path in the computer network to collect at least one of: a round trip time metric, a delay metric, a loss metric, or a jitter metric.

14. The apparatus as in claim 11, wherein the network telemetry indicates at least one of: a probing error, a probe response rate, a round trip time, a packet loss, a path length, or a gap in a packet trace.

15. The apparatus as in claim 11, wherein the process when executed is further configured to:
form an updated probing strategy by updating the probing strategy to swap between the path tracing mode and the metric collection mode to select whichever mode was not selected when forming the probing strategy for the agent; and
instruct the agent to send one or more packets via the computer network according to the updated probing strategy.

16. The apparatus as in claim 15, wherein the apparatus forms the updated probing strategy based in part on an amount of time that has elapsed since it formed the probing strategy.

17. The apparatus as in claim 15, wherein the apparatus forms the updated probing strategy in response to the network telemetry indicating a network configuration change for a host of the agent.

18. The apparatus as in claim 15, wherein the apparatus forms the updated probing strategy based a change in one or more path performance metrics collected by the agent using the one or more packets.

19. The apparatus as in claim 15, wherein the apparatus forms the updated probing strategy based on an indication that a path via which the agent sent the one or more packets has changed.

20. A tangible, non-transitory, computer-readable medium storing program instructions that cause a device to execute a process comprising:
receiving, at the device and via a user interface, an instruction to automate probing strategy formation for an agent in a computer network;
obtaining, by the device, network telemetry from the computer network;
selecting, by the device and using the network telemetry, between a path tracing mode and a metric collection mode to form a probing strategy for the agent, based on the instruction; and
instructing, by the device, the agent in the computer network to send one or more packets via the computer network according to the probing strategy.
